(19) United States
(12) Patent Application Publication
(10) Pub. No.: US 2012/0048869 A1
(43) Pub. Date: Mar. 1, 2012

(54) BEVERAGE IDENTIFIER AND METHOD

(76) Inventor: Edward Pepper, Laguna Niguel, CA (US)

(21) Appl. No.: 12/870,713

(22) Filed: Aug. 27, 2010

(51) Int. Cl. B65D 25/00; B23P 19/04

(52) U.S. Cl. 220/694; 29/428

(57) ABSTRACT

A decorative beverage identifier is made up of a unitarily-formed, resilient and light weight material that can be hung from a beverage container and/or adhered thereto. Preferably such beverage identifiers are formed from a thin foam sheet, and are packaged or grouped so that no two identifiers, or no two sets of identifiers, within a single group share the same shape.

### BACKGROUND

1. Field of the Invention

The present invention relates to the field of decorative beverage vessel identifiers.

2. Description of the Related Art

At social gatherings, conferences, parties and the like, there are frequently several beverages such as water, soft drinks, beer, and wine concentrated in a relatively small area. Many of such beverages typically are contained in identically-shaped vessels of drinkware and are thus indistinguishable from each other when not in the drinker's hand. Consequently, there tends to be confusion as to the ownership of the various drinks, often leading to significant waste.

There have been attempts to provide for the identification and decoration of drinking vessels. Such prior identification devices typically include a complete or incomplete ring configured to hold onto the stem of a glass, a bottle neck, or the like. Indicia such as charms or other decorative items often hang from the ring. Thus, such devices involve multiple parts that must be joined during manufacture. Some such devices grip the associated glass tightly so as to securely hold the hanging charm, and the ring consequently must be constructed of a sturdy material, such as a metal, so as to support the weight of the charm. Due to their complexity, such devices are expensive to manufacture, and thus are inappropriate for marketing as disposable, single-use items. As such, such devices typically are made and sold as sets, and are structurally sturdy enough to endure repeated use.

Such identifiers, however, have significant limitations. For example, for large gatherings a large number of beverage identifiers may be needed. Due to their expense, and the rarity of their use, it is impractical to purchase and store large quantities of identifiers. Also, there is additional concern regarding recovering all of the identifiers after their use, particularly if they are used on disposable bottles or the like. Still further, many gatherings are thematic events, and a single, reusable set of beverage identifiers most likely will not match several different themes.

Loosely-hanging beverage identifiers also have significant disadvantages. For example, as prior identifiers have been manufactured of sturdy, strong materials such as metals, movement of the identifier relative to a container made of glass tends to generate a clanging noise. Further, as loosely-hanging, metallic identifiers likely will slide relative to an associated glassware stem during use, they may interfere with the user's grip on the container. Further, relatively heavy metallic identifiers that slide during use may significantly change the center of gravity of the drinkware during the motion of taking a drink, thus leading to spills. This is particularly true in connection with lightweight (such as plastic) drinking vessels and with children's drinks.

### SUMMARY

Accordingly there is a need in the art for an inexpensive, disposable beverage identifier that is compatible with a broad range of beverage container shapes and sizes. There is also a need in the art for a beverage identifier system that can be customized for particular themes or the like. There is a further need for a beverage identifier that does not interfere with use of the associated drinking vessel.

In accordance with one embodiment, a decorative hanging beverage identifier is provided. The identifier comprises a body comprising an attachment portion and a decorative portion depending from the attachment portion. The body is planar and is formed of a non-metal, resilient, flexible material, and also has unitary construction. An elongate axis extends from a top to a bottom of the body. The attachment portion defines a ring having an aperture and having a break. The aperture is sized and configured to accept an elongate portion of a beverage container. The decorative portion has a shape. The flexible body material is chosen so that the ring can be deflected so the ring portion fits at least partially around the elongate portion of a beverage container disposed in the aperture.

In one such embodiment, the non-metal flexible material has a Shore Durometer 00 scale measurement of about 30-85. In some embodiments, the identifier is made from a material selected from the group consisting of ethylene vinyl acetate, cross-linked polyethylene, fabric, textile, cotton, wool, paper, foam, plastic, nylon, natural or synthetic resin, neoprene, polystyrene, polyethylene, polypropylene, and rubber.

In further embodiments, the non-metal flexible material has a density of about 3 g/cm³ or less. And in another embodiment the non-metal flexible material has a density of about 1 g/cm³ or less, a Shore Durometer 00 scale measurement of between about 30 and 85, and a Young's Modulus of between about 6-50 MPa.

In accordance with another embodiment the present invention provides a system for providing uniquely-shaped beverage identifiers. The system comprises a plurality of planar bodies formed of a non-metal flexible material and having unitary construction. Each planar body is sized and configured to define an ornamental shape and has opposing first and second surfaces. An adhesive is deposited on the first surface. The bodies are divided into uniquely-shaped sets, and no two sets in the system have the same ornamental shape. A plurality of backings are provided, and each set of planar bodies is adhered to one of the backings so that each set of planar bodies is disposed on a different backing. A container encloses the plurality of unique sets of planar bodies.

In some such embodiments, each set comprises at least one planar body. In additional embodiments at least one of the sets comprises a plurality of planar bodies.

In additional embodiments each of the backings has a shape substantially larger than the ornamental shape of the set of planar bodies adhered thereto, and the first surfaces of each planar body is adhered to its corresponding backing so that the backing is exposed immediately adjacent the planar body. Another embodiment additionally comprises a plurality of planar bodies comprising an attachment portion and a decorative portion depending from the attachment portion. The ornamental shape makes up the decorative portion. An elongate axis extends from a top to a bottom of the body. The attachment portion defines an aperture sized and configured to accept an elongate portion of a beverage container.

In accordance with another embodiment, the present invention provides a method of making decorative identifiers. The method comprises assembling a pattern comprising a group of ornamental shapes, the group comprising a plurality of unique sets of such ornamental shapes. Each set of shapes is unique so no two sets within the group have the same shape, and each set comprises at least one identical ornamental shape. The method further comprises cutting the shape pattern from a thin foam sheet so that a thin connection is maintained between each cut shape and surrounding foam so that the group of ornamental shapes can be moved together, and removing all of the cut ornamental shapes in the group from the foam and packaging such shapes in a package.

In some such embodiments at least one of the sets comprises a plurality of cut ornamental shapes, and the embodiments additionally comprise attaching the shapes within the set to one another so that they remain together when in the package. In one such embodiment attaching the shapes within the set comprises adhering the shapes within the set to a common backing.

Another embodiment comprises placing a mask on a surface of the cut foam sheet wherein the mask has holes matching at least some of the cut ornamental shapes, applying adhesive to the exposed portions of the surface of the cut foam sheet, removing the mask from the cut foam sheet, adhering a backing sheet to the top surface of the cut foam sheet; and peeling the unadhered foam from the backing sheet.

In another embodiment the group of ornamental shapes shares a common theme. Some such embodiments additionally comprise assembling a second pattern comprising a second group of ornamental shapes, the second group comprising a plurality of unique sets of such ornamental shapes. Each set of shapes is unique so no two sets within the second group have the same shape, and no two sets within the second group have the same shape as the first group, but each set within the second group having a common theme with the sets within the first group. Each set comprises at least one identical ornamental shape. And the method additionally comprises cutting the second shape pattern from a thin foam sheet so that a thin connection is maintained between each cut shape and surrounding foam so that the group of ornamental shapes can be moved together, removing all of the cut ornamental shapes in the second group from the foam and packaging such shapes in a second package. In further embodiments the second package has a different number of sets of ornamental shapes than does the first package.

### BRIEF DESCRIPTION OF THE DRAWINGS

FIG. 1 depicts a hanging decorative beverage identifier in accordance with one embodiment.

FIG. 2 depicts the hanging decorative beverage identifier of FIG. 1 attached to the stem of a glass.

FIG. 3 depicts a hanging decorative beverage identifier as in FIG. 1 attached to the neck of a bottle.

FIG. 4 schematically depicts hanging identifiers as in FIG. 1 during manufacture.

FIG. 5 depicts an embodiment of an adhesive-coated decorative identifier disposed on a backing.

FIGS. 6A-D depict steps of a manufacturing process of adhesive-backed decorative identifiers in accordance with an embodiment.

FIG. 7 schematically depicts groups of beverage identifiers packaged in accordance with an embodiment.

FIG. 8 schematically represents steps and apparatus enabling customized creation of themed groups of beverage identifiers in accordance with an embodiment.

FIG. 9 depicts another embodiment of a beverage identifier.

### DETAILED DESCRIPTION OF PREFERRED EMBODIMENTS

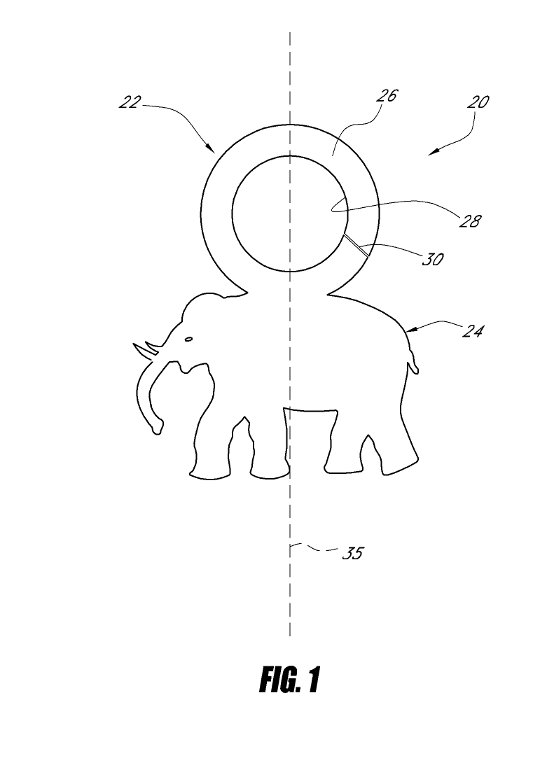

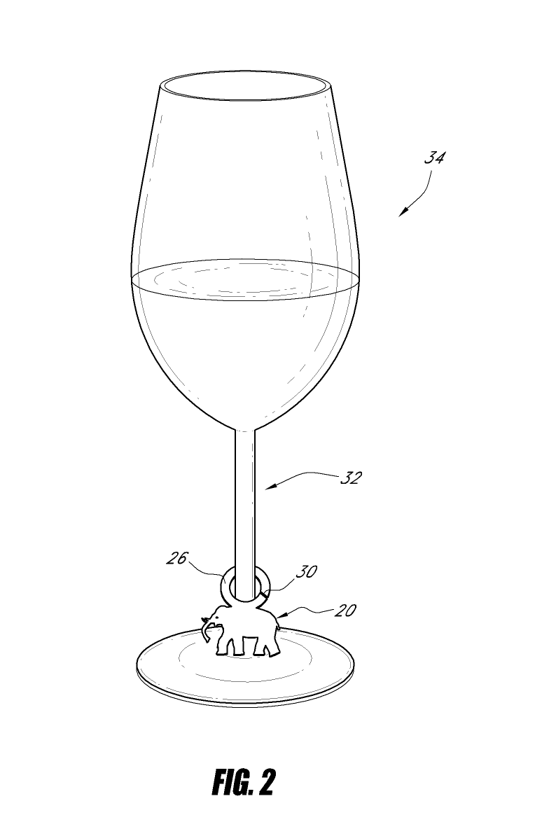

With initial reference to FIG. 1, an embodiment of a hanging decorative beverage identifier 20 is shown. The illustrated embodiment comprises an attachment portion 22 and a decorative or identifying portion 24 that depends from the attachment portion 22. Preferably, the attachment portion and decorative portion are unitarily formed of a nonmetallic, flexible material that is substantially planar. As shown, the decorative portion 24 defines a distinctive shape or the like which can be formed as any desired theme or ornamentation. For example, in the illustrated embodiment, the decorative portion 24 generally approximates the shape of an elephant in accordance with a theme of safari animal shapes. Several unique identifiers, each having a different animal shape, can be provided in accordance with this theme, and thus a user, having applied an identifier to her beverage, can identify her beverage by the unique animal shape of the identifier 20. Of course, other shapes and other themes can be employed, including for example letter or number shapes such as a person's name, initials, age, or the like, or shapes corresponding to hobbies, interests, particular holidays, reasons for celebration and the like.

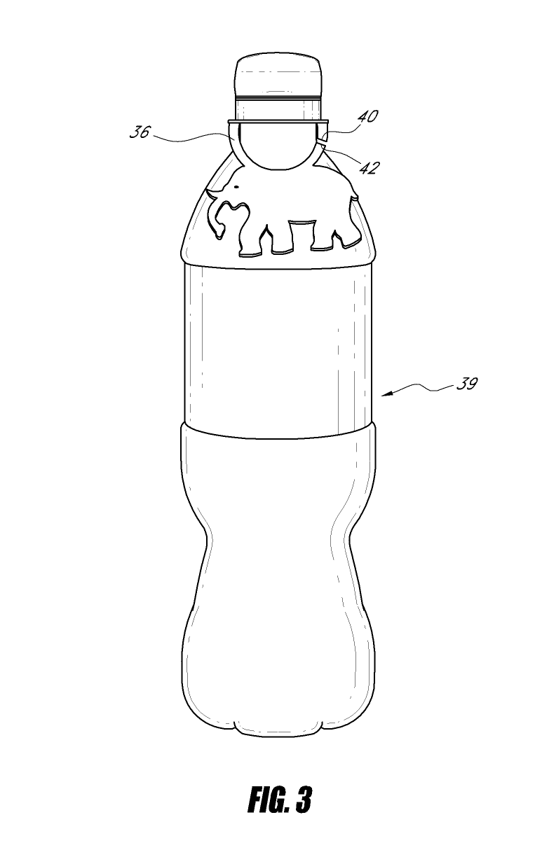

The attachment portion 22, referred to as the ring portion in this embodiment, preferably is disposed above the decorative portion 24 and defines a ring 26 having an aperture 28. Preferably, the aperture 28 includes a break 30 or cut. As such, and with additional reference to FIG. 2, the flexible identifier may be deflected at the break 30 so that the identifier 20 can be slipped about the stem 32 of a beverage container, such as a stemmed glass 34. As shown, the glass stem 32 fits through the ring aperture 28 and the beverage identifier 20 hangs onto the glass 34.

With continued reference to FIG. 1, preferably the beverage identifier 20 has a longitudinal axis 35 extending generally from top to bottom, with the ring portion 22 at the top, and the identifying portion 24 depending therefrom. Preferably, the break 30 in the ring 26 is positioned on one or the other side of the longitudinal axis 35 and is not aligned with the axis. More preferably, and as depicted in the illustrated embodiment, the break 30 is also disposed in the bottom half of the ring portion 22. Nevertheless, in other embodiments, the break can be in other positions, and may even be substantially aligned with the axis 35. Also, the break can have varying shapes. For example, in the illustrated embodiment, the break 30 is a straight cut through the ring portion 22. In other embodiments, the break can comprise a curving line defining an interlock so that portions of the ring portion on opposite edges of the break can lockingly engage and disengage from one another. In further embodiments, the ring need not extend a full 360°, but may extend only partially about a circumference, resulting, for example, in a hook-type shape.

The ring 26 in the illustrated embodiment is substantially circular. However, it is to be understood that ring portions and apertures of varying shapes such as elliptical, polygonal, triangular, square, rectangular, or any uniform, nonuniform, or other ornamental shape can be employed. Further, the ring portion and aperture generally follow and complement each other's shapes in the illustrated embodiments. In other embodiments, the ring portion and aperture may have differing, non-corresponding shapes.

The decorative portion 24 may be of any ornamental design such as animal shapes, geometric shapes, landscapes, thematic elements, automobiles, abstract images, letters, numbers or the like. The decorative portion may even include shapes with additional meanings such as an individual's name, a product logo, an indicator of the type of beverage held within the container, etc.

As noted above, the identifier preferably is formed of a non-metallic, flexible material. Such material preferably is generally lightweight, soft, and is flexible but resilient so that it tends to rebound after deflection toward its at-rest shape. Suitable materials may include fabrics, textiles, cotton, cork, wool, paper, foam, plastic, nylon, natural or synthetic resin, neoprene, polystyrene, polyethylene, polypropylene, or rubber. In a preferred embodiment, the identifiers are cut from sheets of an ethylene vinyl acetate (EVA) foam, such as the EVA foam distributed by Zhihe (Fujian) Technology Co., Ltd., product code: HS codes: 39211100.00, which has a specific gravity of 0.93.

Preferably, the material from which the identifiers are formed has a density of about 3 g/cm³ or less; more preferably, the material has a density of about 2 g/cm³ or less, and most preferably the material has a density of about 1 g/cm³ or less. In other embodiments, the material has a density of about 0.26 g/cm³ or less, and in others about 0.12 g/cm³ or less. In some embodiments, the identifiers are cut from sheets of low density EVA foam, or a blended polyethylene (PE)/EVA foam. As such, the identifier material is much lighter than steel, which is about 7.75-8.05 g/cm³.

Softness, or conversely hardness, can be defined by a material's resistance to indentation. One such measure of hardness is the Shore Durometer (00 scale) measurement, with a higher value representing a harder material. In a preferred embodiment the identifiers range from Durometer Hardness of about 30-85. Materials in this range yield very easily when contacted by harder materials such as glass.

Another consideration for the identifiers is their resilience or elasticity. The modulus of elasticity, or Young's modulus, refers to the ratio of the stretching force per unit cross-sectional area to the elongation per unit length. In a preferred embodiment, EVA-based identifiers have a Young's modulus of about 6-50 MPA, and more preferably between about 10-50 MPA.

The material having an appropriate combination of softness, light weight, and resilient flexibility enables a unitary, one-piece hanging beverage identifier 20 formed out of the material to be easily deformed and slipped on to an elongate portion of a drinking vessel such as the stem 32 of a wine glass 34 or neck of a water bottle. After placement, the material's resilience urges the ring toward its at-rest state with sufficient force to hold the identifier in place. Since the identifier is very light weight, modest resilience is sufficient. Further, the softness of the preferred materials dampens reverberation caused by movement of the identifier relative to the drinking vessel. This is particularly advantageous in preventing the identifier from clanking or causing an otherwise unwanted noise when an identifier moves relative to the beverage vessel during use. Further, the light weight of preferred materials results in identifier embodiments having a negligible effect on the weight of the drinking vessel. This is particularly important for light weight drinking vessels such as disposable plastic stemware, cups and the like. Additionally, when drinking vessels are used by children, who do not have the dexterity to compensate for unpredictable movements, the negligible effect of the identifier on the weight and/or center of gravity of the drinking vessel helps to prevent unwanted spills, even if the identifier moves relative to the vessel during a drinking motion. As such, the material is chosen to have a light-enough weight as discussed above as to have a negligible effect on the center of gravity of the drinking vessel if the identifier moves relative to the drinking vessel as the drinking vessel is moved.

EVA foam as employed in a preferred embodiment can also be printed or written upon by ink pen or pencil. This enables further customization of identifiers. Other embodiments can also employ different materials that may accept printing or writing.

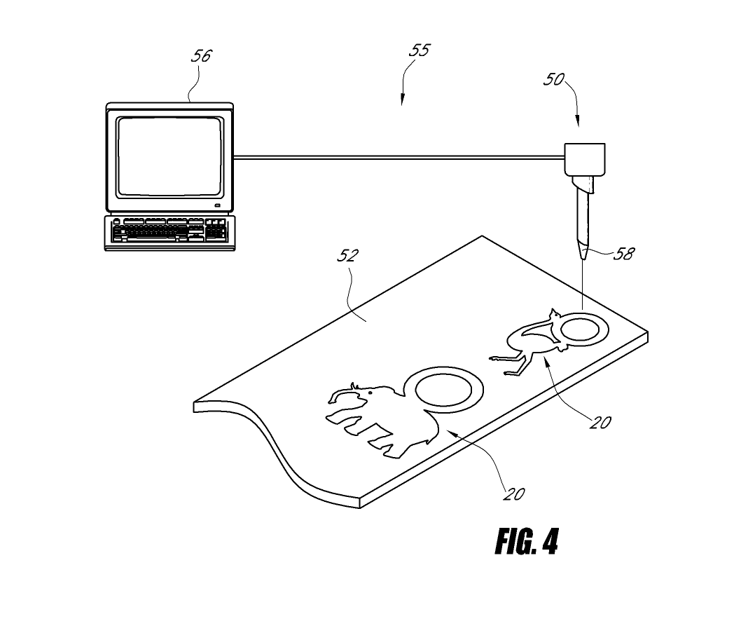

As shown in FIG. 2, in one embodiment the ring aperture 28 is sized so as to have a diameter greater than the diameter of the stem 32 to which the identifier 20 is attached. Thus, after the ring 26 is deformed to fit the ring about the stem 32, the resilient ring 26 generally returns to its original shape, or at least close thereto. Additionally, the identifier may move relative to the vessel during use. It is to be understood, however, that identifiers of various ring diameters may be used with drinking vessels of various shapes and sizes. For example, the ring 36 of the hanging identifier 20 embodiment depicted in FIG. 3 has a larger diameter than does the ring of the embodiment of FIG. 2. However, the bottle 39 shown in FIG. 3 has a relatively short and large-diameter neck, which neck diameter is greater than the diameter of the ring aperture. Thus, when placed on the neck, the ring 36 will not fully regain its original shape and there may be a distance between opposite ends 40, 42 of the ring at the break. Also, the ring 36 may be under some tension as it is deflected by the water bottle neck. Despite this deformation, the resilience of the ring material and shape of the attachment portion is chosen so that the identifier will be held in place during normal use of the drinking vessel. Thus, as shown, preferably the ring deforms to fit onto drinking vessels of various diameters, even diameters greater than the ring diameter.

It is to be understood that hanging identifiers having features as discussed above can be fitted onto the stem of a stemmed glass, the neck of a bottle, or other vessels such as the handle of a mug, a pitcher, a jug, a can or the like. The flexibility of the ring portion and the unitary, one-piece nature of the identifier makes these identifiers particularly versatile and simple to manipulate.

In another embodiment, a hanging identifier does not have a break in the ring portion, such that the identifier can be attached to the bottle by stretching the ring portion and placing it over the neck of the bottle. Preferably, the flexible nature of the hanging identifier permits the ring to flex sufficiently to conform to its position on the drinking vessel.

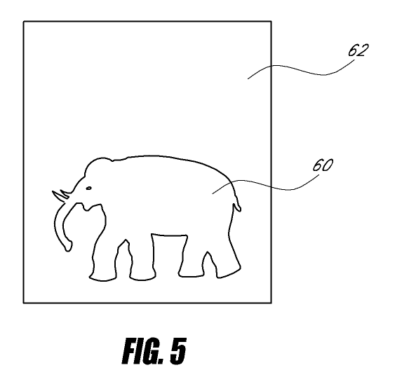

In a preferred embodiment, a plurality of identifiers are cut from a substantially planar sheet of EVA foam having a thickness between about 0.5 m and 3 mm, and more preferably between about 1-2 mm. In some embodiments, identifiers are simultaneously cut from a stack of such foam sheets so as to produce multiple products from a single cutting motion. With reference next to FIG. 4, in one embodiment of manufacturing such identifiers, a computer controlled cutting tool 50 such as a waterjet cutting device cuts identifiers from a planar sheet 52 of EVA foam material. A cutting assembly 55 includes a computer control system 56 having a plurality of identifying shapes and patterns electronically stored therein. A pattern is communicated to a plotted cutting tool 50, which preferably is mounted so as to move in at least an X-Y plane relative to the foam sheets 52. In the illustrated embodiment, the cutting head comprises a nozzle 58, and the cutting tool 50 comprises a high-precision waterjet cutting device that propels a high-speed stream of water through the sheet 52 or sheets of EVA foam to cut out identifiers.

In a preferred embodiment, several different shapes of identifiers 20 are cut out of a single sheet 52 of foam. More specifically, a plurality of identifiers are cut from each sheet, but there are no identifiers with duplicate decorative portions. In other embodiments, multiple groups of unique identifiers are cut from a single large sheet of foam. In such embodiments there are no duplicate identifiers within each group.

Preferably the cuts are made so that the cut identifiers 20 are still tenuously connected to surrounding waste foam 52. As such, the group of unique identifiers can be kept together and manipulated as a group. Eventually, the identifiers will be removed from the associated foam and packaged as a group of unique identifiers. Packaging of identifiers will be discussed further below.

Preferably the computer control enables customization of sheets so that the identifiers on a given sheet, or a group in a sheet, have similar decorative themes or the like. In other embodiments, groups of identical identifiers may be cut from a particular sheet.

In some embodiments, patterns for cutting source material, such as EVA foam sheets, are configured so that all identifiers cut from the same sheet, or a group on a sheet, are packaged together with no duplicates. Once identifiers for a given group are chosen, the computer organizes the identifier shapes into a pattern, which is then communicated to the cutting tool. The pattern is then cut out of the foam sheet.

Preferably the computer-controlled patterns are scalable and easily modifiable to, for example, change the desired size of the identifiers and/or change the size, configuration, shape, or the like of the attachment portions associated with the decorative portions of the identifiers.

In the illustrated embodiment, the cutting device 50 is a waterjet subjected to computer control. It is to be understood that other computer-controlled cutting devices can be employed such as a laser cutter, a sand-based cutting device, a high-speed air-based cutting device, or even a computer-controlled saw blade. In still other embodiments, noncomputer-controlled cutters such as die-based cutting devices may be employed. In one embodiment, a die may be employed to cut one shape at a time from a single or a plurality of sheets of material. In another embodiment, a plurality of dies, each having a unique shape, may be assembled together in a pattern to cut a group of unique identifiers in one cutting motion.

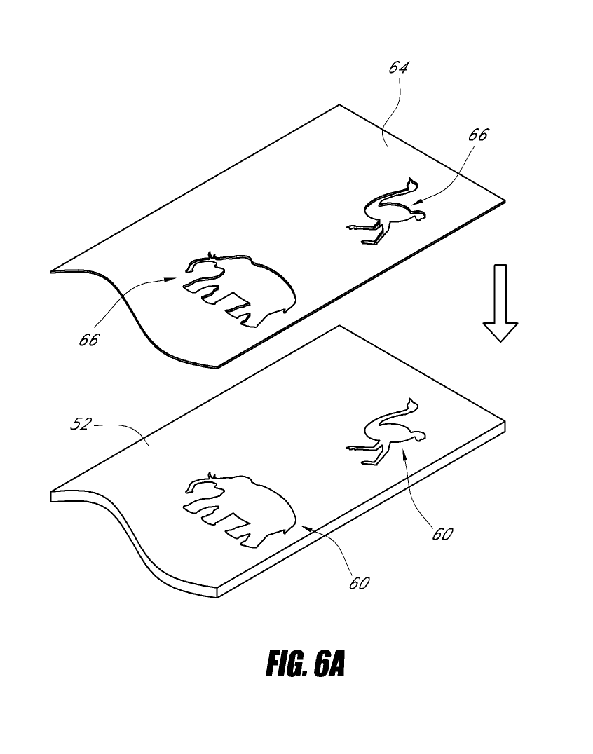

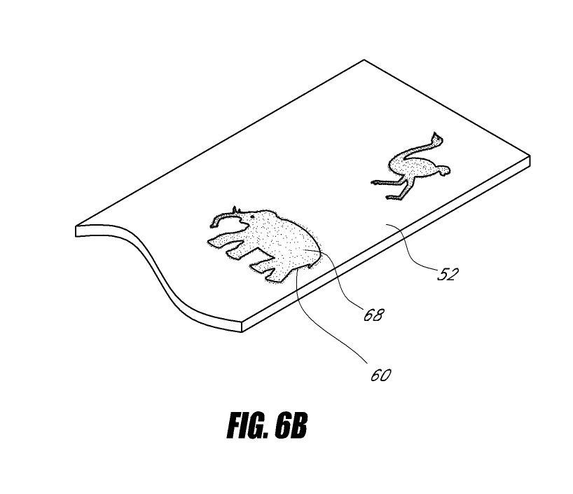

With reference next to FIG. 5, in another embodiment, a decorative identifier 60 comprises a shape formed from a flexible, resilient, unitary piece of material such as the EVA foam sheet described above, but having adhesive on one side rather than having an attachment portion. As illustrated in FIG. 5, preferably the adhesive identifier 60 is adhered to a backing 62 that is not cut along the same shape as the identifier 60. Rather, the backing 62 is larger than the profile of the identifier so that the adhesive-backed identifier 60 can be easily removed from the backing 62 by a user and then adhered to the user's beverage container. In use, preferably a plurality of such adhesive-backed identifiers 60, each identifier having a uniquely-shaped decorative portion, and each identifier placed on a backing 62 that is larger than the identifier profile, are supplied as a group and/or in a single package so that users can be guaranteed to select a unique identifier straight from the group package. The user can then easily peel the identifier off the backing and apply the adhesive-backed identifier to their beverage container for identification purposes.

It is to be understood that, in some embodiments, several unique identifiers are attached to a single backing, and users peel off their choice of identifiers, leaving the backing and remaining identifiers for other users. Also, preferably the adhesive is durable and conducive to more than one use. For example, upon completing a first beverage, the user may peel the identifier off the first beverage container and apply it to the user's next beverage. Also, in some embodiments, after use, the identifiers can be returned to the backing for use again in the future.

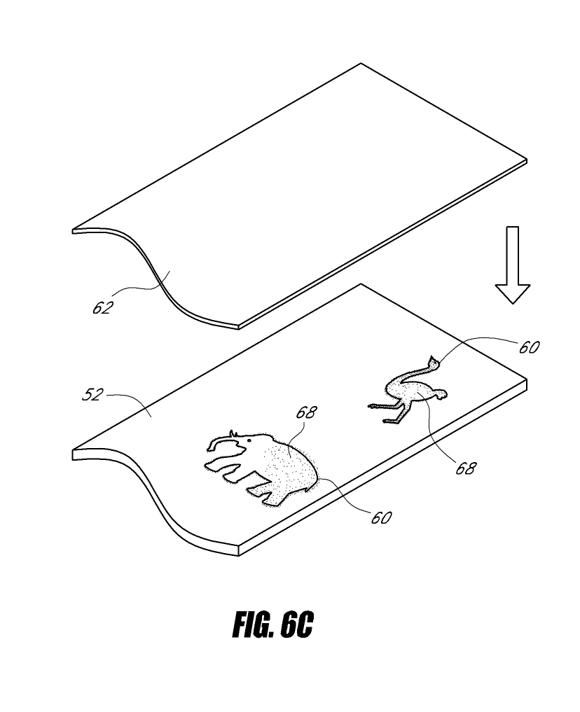

With reference next to FIGS. 6A-6D, in one embodiment, such adhesive-backed identifiers can be manufactured according to the steps as illustrated. More specifically, in FIG. 6A a portion of a sheet 52 of foam is shown in which identifier shapes 60 have been cut from the foam sheet 52 via a water jet cutting device as discussed above. Preferably, when such shapes are cut, one or more small connections between the cut shape and the surrounding foam is left uncut so that the sheet maintains a tenuous hold on the cut shape and the identifier stays with the sheet of foam.

With continued reference to FIG. 6A, a thin template 64 is then advanced over the precut foam sheet 52. The template 64 has apertures 66 that correspond to the cut identifier shapes 60 on the foam sheet 52. However, in the illustrated embodiment, the template apertures 66 are slightly larger than the corresponding cut identifier shapes 60. Once the template 64 is placed over the foam sheet 52 so that the shapes 60 are generally aligned, a layer of adhesive 68 is applied on the template. The adhesive only contacts the sheet 52 through the template apertures 66 formed through the template. Since the apertures 66 are placed to correspond with corresponding shapes 60 on the foam 52, adhesive 68 is applied generally only to the portion of the foam where the cut shapes are located. Such adhesive can be applied in numerous ways. For example, in one embodiment, adhesive is sprayed onto the template and sheet. In other embodiments, a roller impregnated with adhesive is rolled over the template so as to apply adhesive to the foam sheet through the template shape apertures.

As discussed above, in the illustrated embodiment, the apertures 66 in the template 64 are slightly larger than the corresponding shapes 60 cut in the foam sheet 52. As such, and as depicted in FIG. 6B, after adhesive is applied and the template is removed, the adhesive 68 on the foam sheet 62 (shown in the drawing as shading) extends across the entire cut foam shape 60 and slightly beyond the edges.

With reference next to FIG. 6C, a backing 62, which preferably is not cut, is applied to the foam sheet 52. As such, the cut shapes 60 in the foam sheet 52 adhere to the backing 62. Such adherence to the cut identifiers is substantially complete and secure, as the slight adhesive overlap ensures substantially complete adhesive application to the cut identifiers. However, the foam in the space between identifiers is substantially not adhered to the backing.

With reference next to FIG. 6D, after the backing 62 is applied to the foam sheet 52 so that the identifiers 60 adhere to the backing 62, the foam sheet 52 preferably is peeled away from the backing 62. Nearly all of the foam sheet in the spaces between identifier cutouts 60 is unadhered to the backing; thus most of the foam sheet 52 readily peels away from the backing. However, the cutout shapes 60 are substantially fully adhered to the backing 62, and remain in place. Thus, as the waste foam is peeled away, the small connections between the cutouts and the waste foam readily break and the waste foam is removed without disturbing the connection between the identifiers and the backing. The result is a backing sheet 62 with a plurality of foam cutouts 60 adhered thereto.

In a preferred embodiment, the backing sheet with the foam cutouts applied thereon is then cut up into tabs resembling that of FIG. 5, in which the backing 62 is cut so as to be substantially larger than the profile of the foam identifier 60 that is adhered thereto. Preferably, each sheet, or each group on a sheet, has no duplicate identifier shapes. Thus, during processing, the group is cut up into shapes and backing tabs and packaged as a group of non-duplicate identifiers.

In the illustrated embodiment, the template apertures are slightly larger than the actual size of the foam cutouts. In another embodiment, the template apertures can be substantially the same size so as to further avoid application of excessive adhesive. In yet another embodiment, the template apertures are slightly smaller in profile than the profile of the foam cutouts. As such, adhesive is applied to most of the body of each identifier but not directly around the entire edge of each identifier cutout. As such, since there is a lack of adhesive around the edge of the cutout, it is easier for a user to peel the foam identifier off the backing. Also, in such an embodiment, after the user has applied the identifier to one container, if the user wishes to transfer the identifier to another container, it is that much easier for the user to obtain purchase to peel the identifier off the first container for transfer to another container. In yet another embodiment the shape of the template apertures does not match that of the cut identifiers, but still functions to regulate placement of adhesive so that waste foam can be easily pulled away.

The backing 52 can be made of any suitable material for such a backing. For example, in some embodiments the backing is substantially paper with a plastic coating. In another embodiment, the backing is a thin plastic sheet that is treated or conditioned so that the adhesive identifier may be peeled off the backing without damaging either the adhesive or the backing. Preferably, the adhesive is a waterproof adhesive that will remain effective despite moisture accumulation on the exterior of cold drinking vessels. Also, it is to be understood that, in other embodiments, the backing can be adhered to the foam prior to cutting, and the backing and identifier may have substantially the same shape.

In accordance with further embodiments, identifiers can be constructed having features of both the hanging identifiers discussed above in connection with FIGS. 1-4 and the adhesive-backed identifiers discussed in connection with FIGS. 5 and 6. For example, an identifier may be cut to have the shape of a hanging identifier 20 but also have adhesive applied to the entire identifier or a portion thereof. As such, the hanging identifier 20 can be used either solely as a hanging identifier, solely as an adhesive-backed identifier, or as a combination of a hanging identifier and a adhesive-backed identifier with a portion of adhesive helping to maintain the identifier in place in addition to its hanging structure. In one embodiment, a hanging adhesive-backed identifier has adhesive only on a portion of the decorative portion and the attachment portion has no adhesive. In another embodiment, adhesive is applied to the attachment portion so as to assist the ring in attaching to the stem of a glass, but the decorative portion is substantially free of adhesive.

In still further embodiments, an adhesive-backed identifier 60 may have a tab portion connected thereto. The tab portion may take any shape such as a solid tab, or a shape similar to a ring portion with or without an aperture. In one embodiment the tab portion does not have adhesive attached thereto, thus further facilitating easy removal of the identifier from a backing, which in one embodiment may be cut to have substantially the same shape as the identifier. The non-adhered tab may also facilitate further manipulation of the identifier after being initially placed upon a beverage container.

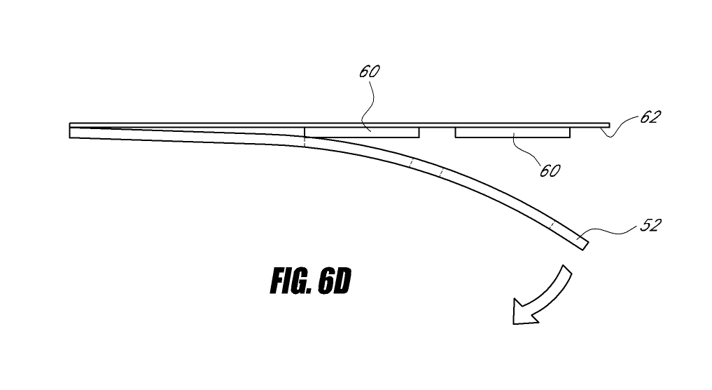

With additional reference next to FIG. 7, preferably beverage identifiers 20, 60 are grouped together along a theme and/or into a group within that theme and in which there are no duplicates within the group. As such, if a group of identifiers is provided at a function, each attendee may have their own unique identifier. In one embodiment, the term “no duplicates” refers to no two beverage identifiers having the same decorative shape. In another embodiment, the term “no duplicates” embraces the possibility of duplicate shapes, but no two beverage identifiers of the same shape also have the same colors, markings, or the like.

Preferably, a first group comprises a plurality of unique beverage identifiers. The first group is made up of hanging identifiers, adhesive-backed identifiers, or both, that are packaged together in an arrangement in which there are no duplicate identifiers within the package 70. For example, a vendor may have tens, hundreds, or thousands of shapes for identifiers, and such shapes preferably are organized into particular themes. In an embodiment as illustrated in FIG. 7, each theme such as, for example, theme “A”, may include many, many identifier shapes. Such identifier shapes may be arranged into groups. For example, group 1 of theme A may have, for example, 50 uniquely-shaped identifiers, and may be packaged in a first group package 70a. Group 2 of theme A may have a similar number, less or more unique shapes, such as for example 100 unique identifier shapes with no duplicates, and may be packaged in a group 2 package 70b. Further, the identifiers of group 2 preferably are unique relative to group 1, meaning there are no duplicates between the two groups. Accordingly in one embodiment, a first-sized package 70a of theme A has a first number of identifiers with no duplicates, known as group 1. A second sized package 70b of theme A, which is known as group 2, includes other identifiers with no duplicates relative to group 1. As such, a user could obtain, depending on their need for numbers of identifiers, a small package 70a (i.e., theme A, group 1), or a large package 70b (i.e., theme A, group 2), or both a small and large package, i.e., theme A, group 1 package and group 2 package, without having any duplicate identifiers. Additionally, a combination package 70c may be made up of all of the group 1 identifiers combined with all the group 2 identifiers. As still a further embodiment, the larger package may have, for example, all the group 1 and group 2 identifiers in combination with a group 3 of identifiers, with no duplicates between the groups so that a package having groups 1, 2, and 3 has no duplicates therewithin.

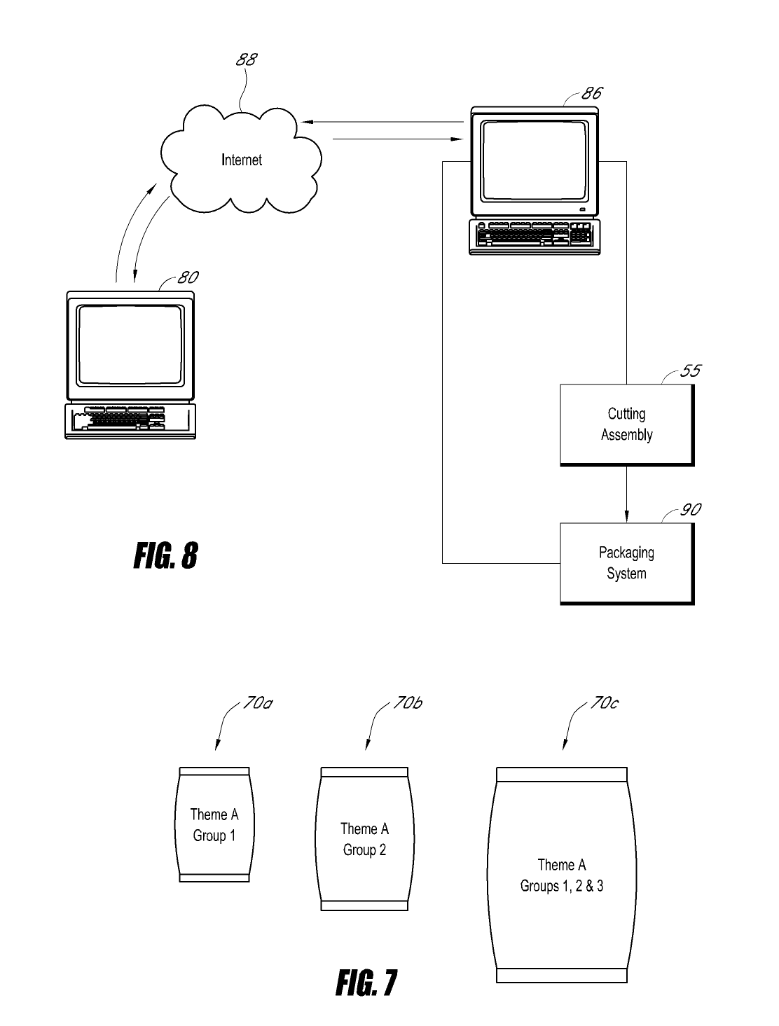

With reference next to FIG. 8, in another embodiment, customized thematic beverage identifiers may be automatically ordered, sorted, manufactured and packaged according to a customer's wishes. For example, a customer computer 80 may contact a vendor computer system 86 via a network such as the internet 88. Software on the vendor computer system 86 comprises tens, hundreds, or thousands of identifier shapes grouped within various themes, colors, groups and the like. The user may choose prematched groups within a theme. The user further may adjust choices such as hanging identifiers 20 with particular-shaped decorative portions, ring portion shapes and/or sizes and select numbers of adhesive-backed identifiers 60. This combination of identifiers can be grouped together with no duplicates. The customer can choose prematched groups or, in other embodiments, may custom-choose shapes within a thematic group. Additionally, in some embodiments, the user can also choose letters, numbers, or the like or even design and request a person's or party attendee's name. For example, the guest of honor may have an identifier in which the decorative portion may be cut to spell out their name. In still another embodiment, the user can submit a photograph, and the vendor software will analyze the photograph and create a shape generally corresponding to the profile in the photograph. Other graphical files may also be submitted by a user. In still other embodiments, the manufacturing process includes a printing machine, and printed images (such as a photographic image, name, date, number, message or the like) can be formed on the identifier.

With continued reference to FIG. 8, preferably, the user, using the vendor software on the vendor computer system 86, can customize the size of the identifiers by, for example, scaling the size, as well as choosing the shape, theme, numbers, colors, and the like. Upon placement of an order, the vendor computer system organizes the chosen shapes so as to appropriately group identifiers to be cut from the source material, such as sheets of EVA foam. The computer controlled cutting assembly 55 is then signaled to manufacture the identifiers. Simultaneously, the vendor computer system 86 can signal a packaging system 90 to prepare to package the cut identifiers as desired, where particular groups are grouped and contained in unique packages rather than jumbling groups together. Each cut and processed group of identifiers is then delivered and packaged in a single package. As such, custom ordering and packaging, and even shipping, can be customer-customized and controlled without the need for excessive inventory or vendor-employed intervention and design. Of course, in other embodiments paper orders through retailers or online forms can be employed, and vendor employees can control the manufacturing, packaging, and/or shipping processes directly.

In accordance with yet another embodiment, preferably a set of two identically-shaped adhesive-backed identifiers is provided on a single backing. Preferably, the matching pair of identifiers is packaged or provided with other single or paired uniquely-shaped identifiers so that the matching pair identifier set is the only set having that shape. More particularly, preferably there are no duplicate sets. In use in accordance with one embodiment at, for example, a child's party, a first one of the identifiers of the set is applied to a child's beverage, and the second one of the identifier pair set is applied to the child's clothing or the like. As such, the child need not remember which identifier shape is theirs. Instead, their identifier shape is with them at all times and the child and/or an adult or other event attendant can match the child with the appropriate beverage container.

In other embodiments, a matching set of two, three, or more identically-shaped identifiers are provided on a single backing, but a single package or group of unique identifiers preferably will include no duplicate matching sets. A matching identifier set may be dispatched to a family, couple, or other group of attendees. Since all the members of that particular attendee group have the same identifier, members of that attendee group may more easily remember which drink is theirs versus others in their same attendee group. Also, the identically-shaped identifiers may prompt discussion of the connection between the members of the particular attendee group. In yet another embodiment, each matching identifier set may share identically-shaped identifiers but each identifier in the matching set is a different color. In another embodiment, a single user may employ a matching set of identically-shaped identifiers to track multiple beverages.

Thus, in one embodiment, matching sets of identically-shaped identifiers are provided in a group package or the like so that the matching identifier set is held or otherwise provided together without requiring a user to search for matching-shaped identifiers. Also, although identifiers within a set may share a common shape, preferably no two identifier sets in a single group or package share a common shape. In some embodiments, an identifier set may comprise both hanging beverage identifiers and adhesive-backed identifiers. Manufacturing processes can be tailored so that both adhesive-backed and hanging identifiers are provided together, such as adhered to the same backing. Applicant contemplates that any of a multitude of processes can be employed to provide two or more identifiers on a single backing. For example, in one embodiment, a single backing can be placed between two EVA sheets (before or after cutting of shapes), and identifiers of matching shapes can be adhered to both sides of the backing.

Embodiments employing matching sets of identifiers are also amenable to themed parties or educational settings such as, for example, children choosing their favorite animal and forming a set with other children who choose animals with similar features (for example animals with the same number of legs).

Uniquely-shaped and/or unique sets of beverage identifiers are also amenable to group attendees at a gathering. For example, groups of identifiers may share commonalities such as, for example, animals from a particular continent or animals with a particular number of legs, horns, etc. Groups can also follow particular themes such as letters, or groups demarcated by a number. In some embodiments attendees may be assigned to a room or table based upon the theme of the identifier they choose or are assigned.

Use of such themed identifiers can be particularly amenable to games and activities to help introduce people and get people familiar with each other. Ideas for such games may be printed on a package of identifiers and/or included as printed material provided within the package. In one example, two or more people at a gathering can be assigned the same animal and their task is to find the other person or persons with the same animal. Variations on this theme are available such as non-identical shapes that share a relationship. For example, the possessor of a fishing pole may be tasked with finding other people with a fish or fishing boat, or the bearer of an automobile-shaped identifier may be tasked with finding someone with a gas station-shaped identifier, tow-truck-shaped identifier, or the like. An event may have a game requiring attendees to seek out and find others having identifiers within their theme group. Users may be left to themselves to determine what the theme or commonality of their theme group is or may be provided with a list of what other identifiers are associated with their theme group. Further activities may include requiring users to find the person or other persons in their theme group, and complete a questionnaire asking basic information about theme group members to help people get to know one another. Players would then submit their completed questionnaires for the chance to win a prize.

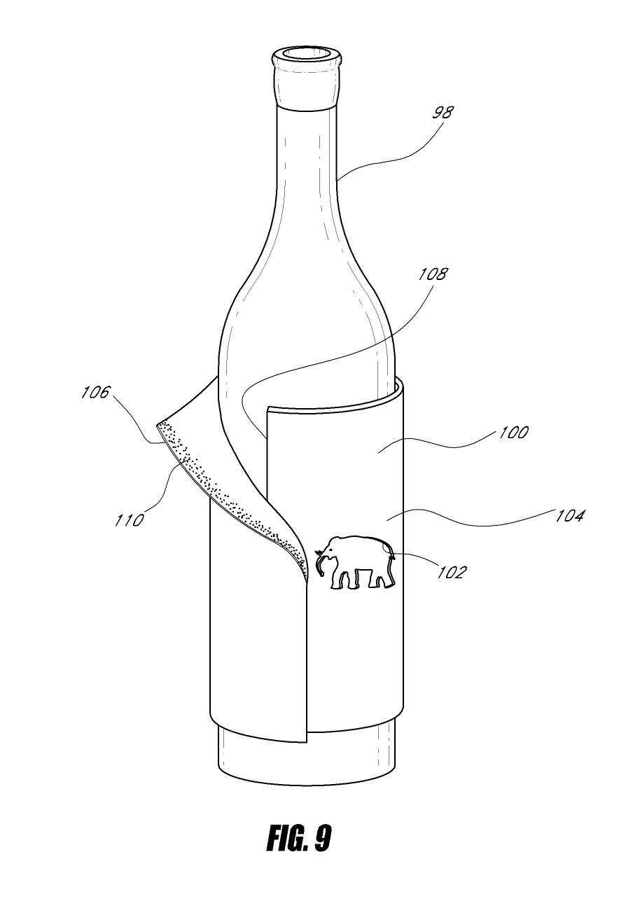

In another embodiment, and with reference to FIG. 9, a flat, flexible, unitary sheet 100 of material such as EVA foam is shaped having a size sufficient to wrap about a container such as a conventional aluminum can or beverage bottle 98. Preferably, the identifier wrap 100 has one or more unique decorative shapes 102 cut out of a body portion 104 of the wrap 100 so as to be identifiable to the owner of the associated beverage. Also, in embodiments employing a foam or the like, the wrap 100 may help insulate the beverage within the can or bottle 98.

In the illustrated embodiment, adhesive 110 is disposed at and adjacent a first end 106 of the wrap 100. As such, the wrap 100 is wrapped about the can or bottle 98 with the first end 106 overlapping a second end 108, and is adhered to itself to hold it in place on the can. This enables the user to later remove the wrap 100 from an empty can or bottle when finished. Also, since the adhesive 110 is placed to only engage the wrap 100, the bottle's paper label will not peel off when the wrap is removed. As such, the wrap's adhesive remains unfouled, and the wrap can be reused.

In another embodiment, spaced-apart portions of adhesive are provided on the body 104 of the wrap 100. As such, the wrap is held securely on the bottle or can, but again, the wrap preferably is not so securely held to the bottle that a label of the bottle will remain adhered to the wrap when it is removed.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. For example, options concerning unique packaging, order-customization material or choice, and the like can be applied to hanging identifiers, adhesive-backed identifiers, identifying wraps, and/or hybrids of these embodiments, taken alone or in combination. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A decorative hanging beverage identifier comprising:
a body comprising an attachment portion and a decorative portion depending from the attachment portion, the body being planar and being formed of a non-metal, resilient, flexible material, and having unitary construction, an elongate axis extending from a top to a bottom of the body;
the attachment portion defining a ring having an aperture and having a break, the aperture sized and configured to accept an elongate portion of a beverage container, the decorative portion having a shape, the flexible body material chosen so that the ring can be deflected so the ring portion fits at least partially around the elongate portion of a beverage container disposed in the aperture.

2. The identifier of claim 1, wherein the non-metal flexible material has a Shore Durometer 00 scale measurement of about 30-85.

3. The identifier of claim 1, wherein the identifier is made from a material selected from the group consisting of ethylene vinyl acetate, cross-linked polyethylene, fabric, textile, cotton, wool, paper, foam, plastic, nylon, natural or synthetic resin, neoprene, polystyrene, polyethylene, polypropylene, and rubber.

4. The identifier of claim 1, wherein the non-metal flexible material has a density of about 3 g/cm³ or less.

5. The identifier of claim 1, wherein the non-metal flexible material has a density of about 1 g/cm³ or less, a Shore Durometer 00 scale measurement of between about 30 and 85, and a Young's Modulus of between about 6-50 MPa.

6. A system for providing uniquely-shaped beverage identifiers, comprising:
a plurality of planar bodies formed of a non-metal flexible material, and having unitary construction, each planar body sized and configured to define an ornamental shape and having opposing first and second surfaces, an adhesive being deposited on the first surface, the bodies divided into uniquely-shaped sets, and no two sets in the system have the same ornamental shape;
a plurality of backings, each set of planar bodies adhered to one of the backings so that each set of planar bodies is disposed on a different backing; and
a container enclosing the plurality of unique sets of planar bodies.

7. A system as in claim 6, wherein each set comprises at least one planar body.

8. A system as in claim 7, wherein at least one of the sets comprises a plurality of planar bodies.

9. A system as in claim 7, wherein each of the backings has a shape substantially larger than the ornamental shape of the set of planar bodies adhered thereto, and wherein the first surfaces of each planar body is adhered to its corresponding backing so that the backing is exposed immediately adjacent the planar body.

10. A system as in claim 7, additionally comprising a plurality of planar bodies comprising an attachment portion and a decorative portion depending from the attachment portion, the ornamental shape making up the decorative portion, an elongate axis extending from a top to a bottom of the body, the attachment portion defining an aperture sized and configured to accept an elongate portion of a beverage container.

11. A method of making decorative identifiers, comprising:
assembling a pattern comprising a group of ornamental shapes, the group comprising a plurality of unique sets of such ornamental shapes, each set of shapes being unique so no two sets within the group have the same shape, each set comprising at least one identical ornamental shape;
cutting the shape pattern from a thin foam sheet so that a thin connection is maintained between each cut shape and surrounding foam so that the group of ornamental shapes can be moved together;
removing all of the cut ornamental shapes in the group from the foam and packaging such shapes in a package.

12. A method as in claim 11, wherein at least one of the sets comprises a plurality of cut ornamental shapes, and additionally comprising attaching the shapes within the set to one another so that they remain together when in the package.

13. A method as in claim 12, wherein attaching the shapes within the set comprises adhering the shapes within the set to a common backing.

14. A method as in claim 11, comprising placing a mask on a surface of the cut foam sheet wherein the mask has holes matching at least some of the cut ornamental shapes, applying adhesive to the exposed portions of the surface of the cut foam sheet, removing the mask from the cut foam sheet, adhering a backing sheet to the top surface of the cut foam sheet; and peeling the unadhered foam from the backing sheet.

15. A method as in claim 11, wherein the group of ornamental shapes share a common theme.

16. A method as in claim 15 additionally comprising assembling a second pattern comprising a second group of ornamental shapes, the second group comprising a plurality of unique sets of such ornamental shapes, each set of shapes being unique so no two sets within the second group have the same shape, and no two sets within the second group have the same shape as the first group, but each set within the second group having a common theme with the sets within the first group, each set comprising at least one identical ornamental shape, cutting the second shape pattern from a thin foam sheet so that a thin connection is maintained between each cut shape and surrounding foam so that the group of ornamental shapes can be moved together, removing all of the cut ornamental shapes in the second group from the foam and packaging such shapes in a second package.

17. A method as in claim 16, wherein the second package has a different number of sets of ornamental shapes than does the first package.
